(19) United States
(12) Patent Application Publication
(10) Pub. No.: US 2010/0042677 A1
(43) Pub. Date: Feb. 18, 2010

(54) TWO-WAY COMMUNICATION SYSTEM, SERVER UNIT, REPEATER, TWO-WAY COMMUNICATION METHOD AND PROGRAM

(76) Inventor: Kazushige Ishikawa, Tokyo (JP)

Correspondence Address: Mr. Jackson Chen, 6535 N. STATE HWY 161, IRVING, TX, 75039, US

(21) Appl. No.: 12/447,122

(22) PCT Filed: Oct. 2, 2007
(86) PCT No.: PCT/JP2007/069252

§ 371 Date: Apr. 24, 2009

(30) Foreign Application Priority Data
Oct. 26, 2006 (JP) 2005-291203

(51) Int. Cl. G06F 15/16

(52) U.S. Cl. 709/203

(57) ABSTRACT

When the number of connections which can be simultaneously established between a server unit and client units is limited in the server unit, the server unit according to the present invention enables to simultaneously conduct two-way communication with many client units. There are provided a plurality of client units, a server unit, and a repeater, wherein each of the plural client units includes a client-side communication module to transmit data to the server unit via an uplink connection established between itself and the server unit, the server unit includes a server-side communication module to send data to be sent to the client unit via a junction line to the repeater, and the repeater includes a repeater-side communication module to transmit the data sent from the server unit to the plural client units via downlink connections established between itself and the plural client units.

### TECHNICAL FIELD

The present invention relates to a technique to conduct two-way communication between a server unit and client units, and in particular, to a technique in which when the number of connections which can be simultaneously established in the server unit is limited, the server unit is enabled to conduct the two-way communication with a possibly largest number of client units.

### RELATED ART

As a technique related to communication between a server unit and client units, there is known a technique in which an uplink connection and a downlink connection are established between the server unit and the client units to carry out the two-way communication between the server unit and the client units (reference is to be made to, for example, Patent Documents 1 and 2).

FIG. 1 is a block diagram showing a configuration example of a two-way communication system described in Patent Documents; the system includes a server unit 910 and a plurality of client units connected to the server unit 910; the client units 940 and 950 are coupled with the server unit 910 via HTTP communication means 990 including means that transmits only HTTP.

In the two-way communication system shown in FIG. 1, to enable two-way communication between the server unit 910 and the client units 940 and 950, operation is conducted as follows. That is, to enable data transmission from the server unit 910 to the client units 940 and 950 in a realtime fashion, a downlink connection using a GET method of HTTP is beforehand established, and to enable data transmission from the client units 940 and 950 to the server unit 910 in a realtime manner, an uplink connection using a POST method of HTTP is beforehand established.

Thereafter, when a request to send data to the server unit 910 is issued from client application programs (client AP) 941 and 951, communication modules 942 and 952 in the client units 940 and 950 transmit data via the uplink connection to the server unit 910. Also, when a request to send data to the client units 940 and 950 is issued from a server application program (server AP) 911, a communication module 912 in the server unit 910 sends data via the downlink connection to the client units 940 and 950.

Patent Document 1: Japanese Patent Pub. No. 3478200
Patent Document 2: Japanese Patent Laid-Open Pub. No. 2004-5427

### DISCLOSURE OF THE INVENTION

### Problem to be Solved by the Invention

According to the techniques described in Patent Documents described above, two-way communication is possible between the server unit 910 and the client units 940 and 950, but there exists the following problem. That is, in the server unit 910, due to the restriction on resources available to establish connections and the specification and the like of the WWW server capable of interpreting and processing HTTP, the number of connections which can be simultaneously established is limited in some cases; in such cases, the number of client units which can conduct two-way communication is reduced.

Therefore, an exemplary object of the present invention resides in that even in a situation wherein the number of connections which can be simultaneously established is limited in the server unit, the server unit enables to simultaneously conduct two-way communication with many client units.

### Means for Solving the Problem

A first two-way communication system according to an exemplary aspect of the present invention includes a plurality of client units, a server unit, and a repeater, wherein each of the plural client units includes a client-side communication module to transmit data to the server unit via an uplink connection established between itself and the server unit, the server unit includes a server-side communication module to send data to be sent to the client unit, via a junction line to the repeater; and the repeater includes a repeater-side communication module to transmit the data sent from the server unit to the plural client units via downlink connections established between itself and the plural client units.

A second two-way communication system according to an exemplary aspect of the present invention includes a plurality of client units, a plurality of server units, and a repeater, wherein each of the plural client units includes a client-side communication module to transmit data to the plural server units via uplink connections established between itself and the plural server units, each of the plural server units includes a server-side communication module to send data to be sent to the client unit, via a junction line to the repeater; and the repeater includes a repeater-side communication module to transmit the data sent from the plural server units to the plural client units via downlink connections established between itself and the plural client units.

A server unit according to an exemplary aspect of the present invention is a server unit as a constituent component of a two-way communication system including a plurality of client units, a server unit, and a repeater, wherein each of the plural client units includes a client-side communication module to transmit data to the server unit via an uplink connection established between itself and the server unit, and the repeater includes a repeater-side communication module to transmit data sent from the server unit to the plural client units via downlink connections established between itself and the plural client units, the server unit including a server-side communication module to send data to be sent to the client units, via a junction line to the repeater.

A repeater according to an exemplary aspect of the present invention is a repeater as a constituent component of a two-way communication system including a plurality of client units, a server unit, and a repeater, wherein each of the plural client units includes a client-side communication module to transmit data to the server unit via an uplink connection established between itself and the server unit, and the server unit includes a server-side communication module to send data to be sent to the client unit, via a junction line to the repeater, the repeater including a repeater-side communication module to transmit the data sent from the server unit to the plural client units via downlink connections established between itself and the plural client units.

In a two-way communication method according to an exemplary aspect of the present invention, a plurality of client units transmit data pieces to a server unit via uplink connections established between the client units and the server unit, the server unit sends data pieces to be sent to the client units, via a junction line to a repeater; the repeater transmits the data pieces sent from the server unit to the client units via downlink connections established between the repeater and the plural client units.

A first program according to an exemplary aspect of the present invention is a program to implement, by a computer, a server unit as a constituent component of a two-way communication system including a plurality of client units, a server unit, and a repeater, wherein each of the plural client units includes a client-side communication module to transmit data to the server unit via an uplink connection established between itself and the server unit, and the repeater includes a repeater-side communication module to transmit data sent from the server unit to the plural client units via downlink connections established between itself and the plural client units, the program making the computer function as a server-side communication module to send data to be sent to the client units, via a junction line to the repeater.

A second program according to an exemplary aspect of the present invention is a program to implement, by a computer, a repeater as a constituent component of a two-way communication system including a plurality of client units, a server unit, and a repeater wherein each of the plural client units includes a client-side communication module to transmit data to the server unit via an uplink connection established between itself and the server unit, and the server unit includes a server-side communication module to send data to be sent to the client unit via a junction line to the repeater, the program making the computer function as a repeater-side communication module to transmit the data sent from the server unit to the plural client units via downlink connections established between the repeater and the plural client units.

### ADVANTAGES OF THE INVENTION

In accordance with the present invention, there can be attained an advantage in which even in a situation wherein the number of connections which can be simultaneously established is limited in the server unit, the server unit enables to simultaneously conduct two-way communication with many client units. The reason therefor resides in that when data is transmitted from the client unit to the server unit, the data is sent via an uplink connection established between the client unit and the server unit, and when data is transmitted from the server unit to a client unit, the server unit sends to a repeater the data to be sent and then the repeater transmits the data via a downlink connection established between the repeater and the client unit to the client unit. That is, in the server unit, it is necessary to establish only the uplink connection of the uplink and downlink connections which are required to conduct two-way communication with the client unit; therefore, when compared with the techniques of Patent Documents in which both of the uplink and downlink connections are required to be established in the server unit, the number of client units which can simultaneously conduct two-way communication is doubled.

### BEST MODE FOR CARRYING OUT THE INVENTION

Next, description will be given in detail of a best mode for carrying out the invention by referring to drawings.

### First Exemplary Embodiment

Referring to FIG. 2, a first exemplary embodiment of a two-way communication system in accordance with the present invention includes a server unit 110, a downlink communication repeater 130, and a plurality of client units 140 and 150. In the diagram, only two client units 140 and 150 are shown; however, within a range of the restriction for the number of connections which the server unit 110 can establish at the same time, it is also possible to dispose three or more client units.

The server unit 110 includes a server AP 111 as well as a communication module 112 for the downlink communication repeater 130 and the dine units 140 and 150.

The downlink communication repeater 130 includes a communication module 132 for the server unit 110 and the client units 140 and 150. The serve unit 110 and the downlink communication repeater 130 are isolated by a firewall called DMZ from an external network (internet), and hence a unique protocol may be employed for communication therebetween.

The client units 140 and 150 include client APs 141 and 151 as well as communication modules 142 and 152 for the server unit 110 and the downlink communication repeater 130.

When data is sent from the client AP 141 to the server AP 111, the communication module 142 in the client unit 140 transmits to the communication module 112 in the server unit 110 an HTTP POST request (simply described as a POST request in some cases) having to-be-transmitted data in an HTTP body section. Further, when data is sent from the client AP 151 to the server AP 111, similar operation is performed. In the diagram, the flow of uplink data from the client AP to the server AP is represented using a solid-line arrow.

Conversely, when data is sent from the server AP 111 to the client AP 141, the communication module 112 in the server unit 110 first transmits data, via a relay or junction line according to a unique protocol, to the communication module 132 in the downlink communication repeater 130. Next, the data is sent from the communication module 132 in the downlink communication repeater 130 to the communication module 142 in the client unit 140 as an HTTP GET response (simply described as a GET response in some cases) to an HTTP GET request (simply described as a GET request in some cases) delivered from the communication module 142 in advance. Moreover, also when data is sent from the server AP 111 to the client AP 151, similar operation is conducted. In the diagram, the flow of downlink data from the server AP to the client AP is indicated by a broken-line arrow.

Next, referring to FIG. 3, description will be given in detail of configurations and operations of the server unit 110, the downlink communication repeater 130, and the client units 140 and 150.

Referring to FIG. 3, the communication module 112 of the server unit 110 includes data transmission means 213, HTTP POST request reception means 217, HTTP POST request analysis means 215, HTTP POST response creation means 214, and HTTP POST response transmission means 216, and is related to data reception means 211 and data transmission means 212. The data reception means 211 has a function to pass data sent from a client unit to a server AP, not shown in FIG. 3, and the data transmission means 212 has a function to pass to the data transmission means 213 transmission data which is passed from the server AP and which is addressed to the client unit. Incidentally, the server unit 110 is feasible by a computer; if the server unit 110 is realized by a computer, it is implemented, for example, as follows. A disk, a semiconductor memory, or any other recording medium having recorded a program which makes a computer function as the server unit 110 is prepared, and the computer is made to read the program. The computer controls its own operation according to the program thus read, to thereby realize on its own computer the data reception means 211, the data transmission means 212, the data transmission means 213, the HTTP POST response creation means 214, the HTTP POST request analysis means 215, the HTTP POST response transmission means 216, and the HTTP POST request reception means 217.

The communication module 132 of the downlink communication repeater 130 includes data reception means 231, transmission data storage means 232, HTTP GET request reception means 236, transmission destination identifying means 234, HTTP GET response creation means 233, and HTTP GET response transmission means 235. The downlink communication repeater 130 may be realized by a computer; if the downlink communication repeater 130 is realized by a computer, it is implemented, for example, as follows. A disk, a semiconductor memory, or any other recording medium having recorded a program which makes a computer function as the downlink communication repeater 130 is prepared, and the computer is made to read the program. The computer controls its own operation according to the program thus read, to thereby realize on its own computer the data reception means 231, the transmission data storage means 232, the HTTP GET response creation means 233, the transmission destination identifying means 234, the HTTP GET response transmission means 235, and the HTTP GET request reception means 236.

The communication module 142 of the client unit 140 includes HTTP POST request creation means 244, HTTP POST request transmission means 242, HTTP POST response reception means 241, HTTP POST response analysis means 243, HTTP GET request creation means 248, HTTP GET request transmission means 246, HTTP GET response reception means 245, and HTTP GET response analysis means 247, and is related to data transmission means 249 and data reception means 250. The data transmission means 249 has a function to pass to the communication module 142 transmission data passed from a client AP, not shown in FIG. 3, and the data reception means 250 has a function to pass to the client AP data transmitted via the downlink communication repeater 130 from the server unit 110. In this connection, the client unit 140 is implementable by a computer; and if the client unit 140 is realized by a computer, it is implemented, for example, as follows. A disk, a semiconductor memory, or any other recording medium having recorded a program which makes a computer function as the client unit 140 is prepared, and the computer is made to read the program. The computer controls its own operation according to the program thus read, to thereby realize on its own computer the HTTP POST response reception means 241, the HTTP POST request transmission means 242, the HTTP POST response analysis means 243, the HTTP POST request creation means 244, the HTTP GET response reception means 245, the HTTP GET request transmission means 246, the HTTP GET response analysis means 247, the HTTP GET request creation means 248, the data transmission means 249, and the data reception means 250.

<Operation when Data is Transmitted from Client Unit to Server Unit>

When data is transmitted from the data transmission means 249 of the client unit 140 to the data reception means 111 of the server unit 110, operation is conducted as follows.

First, in the client unit 140, the client AP 141 passes to-be-transmitted data via the data transmission means 249 to the communication module 142. In response thereto, the HTTP POST request creation means 244 in the communication module 142 creates an HTTP POST request including the to-be-transmitted data in its HTTP body section. The created HTTP POST request is sent from the HTTP POST request transmission means 242 to the server unit 110; using this as a trigger, an uplink connection is established between the client unit 140 and the server unit 110. In the operation, it is possible that the data passes HTTP communication means 290 including means to transmit only HTTP traffic.

In the server unit 110, the HTTP POST request reception means 217 receives the HTTP POST request sent from the client unit 140. Thereafter, the HTTP POST request analysis means 215 analyzes the HTTP POST request received by the HTTP POST request reception means 217 to attain data from the HTTP body section. Furthermore, the HTTP POST request analysis means 215 transfers the attained data via the data reception means 211 to the server AP 111 and notifies success of the POST request analysis to the HTTP POST response creation means 214. As a result, the HTTP POST response creation means 214 creates an HTTP POST response (to be simply described as a POST response in some cases) to be replied. The created POST response is transmitted from the HTTP POST response transmission means 216 to the client unit 140.

In the client unit 140, the HTTP POST response reception means 241 receives the POST response sent from the server unit 110. The HTTP POST response analysis means 243 analyzes the POST response received by the HTTP POST response reception means 241 and notifies success of the data transmission to the server unit 110 via the data transmission means 249 to the client AP 141. This extinguishes the downlink connection between the client unit 140 and the server unit 110.

<Operation when Data is Sent from Server Unit to Client Unit>

When data is transmitted from the data transmission means 212 of the server unit 110 to the data reception means 250 of the client unit 140, operation is conducted as follows.

First, in the client unit 140, the data reception means 250 requests the HTTP GET request creation means 248 to receive data. This causes the HTTP GET request creation means 248 to create an HTTP GET request. The created GET request is transmitted from the HTTP GET request transmission means 246 to the downlink communication repeater 130; using this as a trigger, a downlink connection is established between the client unit 140 and the downlink communication repeater 130. In this case, it is possible that the data passes the HTTP communication means 290 including means to transmit only HTTP traffic.

In the downlink communication repeater 130, the HTTP GET request reception means 236 receives the GET request sent from the client unit 140 to pass the request to the transmission destination identifying means 234. The transmission destination identifying means 234 stores therein the received GET request as information indicating the downlink connection to the client unit 140.

On the other hand, in the server unit 110, the server AP 111 passes data to be transmitted to the client unit 140, via the data transmission means 212 to the data transmission means 213. This data is sent from the data transmission means 213 to the downlink communication repeater 130. In the operation, although the data passes the communication means 295, there does not exist any restriction on the communication means 295 such that it includes means to transmit only HTTP; hence, it is communication means based on its own protocol.

In the downlink communication repeater 130, the data reception means 231 receives the data sent from the server unit 110 and issues a query to the transmission destination identifying means 234 to determine whether or not a downlink connection has been established to the client unit 140 as the transmission destination of the received data.

In response thereto, the transmission destination identifying means 234 makes a check to determine whether or not the GET requests stored therein include the GET request sent from the client unit 140. If such GET request is present, the transmission destination identifying means 234 returns to the data reception means 231 a response indicating that the downlink connection to the client unit 140 has been established; and further deletes the GET request sent from the client unit 140 in the stored GET requests from the control range of the transmission destination identifying means 234. In contrast thereto, if such GET request is absent, the transmission destination identifying means 234 returns a response indicating that the downlink connection to the client unit 140 has not been established.

And if the response indicating that the downlink connection has been established is returned, the data reception means 231 passes the transmission data to the client unit 140 via the transmission destination identifying means 234 to the HTTP GET response creation means 233. The HTTP GET response creation means 233 creates an HTTP GET response including to-be-transmitted data in its HTTP body section. The created HTTP GET response is sent from the HTTP GET response transmission means 235 to the client unit 140.

In the client unit 140, the HTTP GET response reception means 245 receives the GET response sent from the downlink communication repeater 130, and the HTTP GET response analysis means 247 analyzes the GET response to extract data from the HTTP body section and passes the extracted data via the data reception means 250 to the client AP 141. This extinguishes the downlink connection between the client unit 140 and the downlink communication repeater 130.

In contrast thereto, if a response indicating that the downlink connection has not been established to the client unit 140 as the transmission destination of the data is returned from the transmission destination identifying means 234, the data is once stored in the transmission data storage means 232. Then, at processing timing (in general, timing when a GET request is received) of the transmission data stored in the transmission data storage means 232, the data reception means 231 pays attention to one of the data pieces stored in the transmission data storage means 232 and issues a query to the transmission destination identifying means 234 to determine whether or not a downlink connection has been established to the client unit as the transmission destination of the data.

And if a response indicating that the downlink connection has been established is returned from the transmission destination identifying means 234, the data reception means 231 obtains the data under consideration from the transmission data storage means 232 and passes it via the transmission destination identifying means 234 to the HTTP GET response creation means 233. In contrast thereto, if a response indicating that the downlink connection has not been established is returned from the transmission destination identifying means 234, the data reception means 231 waits for next processing timing.

Next, referring to a flowchart of FIG. 4, description will be given in detail of operation when data is sent from the server unit 110 to the client unit 140.

First, the client unit 140 beforehand transmits an HTTP GET request to the downlink communication repeater 130 (step S311). In more detail, the data reception means 250 in the client unit 140 issues a data reception query to the HTTP GET request creation means 248; in response thereto, the HTTP GET request creation means 248 creates a GET request and sends the created GET request by using the HTTP GET request transmission means 246 to the downlink communication repeater 130.

The downlink communication repeater 130 receives the GET request delivered from the client unit 140 and blocks the GET request until occurrence of data to be transmitted to the client unit 140 (step S321). More concretely, the HTTP GET request reception means 236 in the downlink communication repeater 130 receives the GET request from the client unit 140, and the transmission destination identifying means 234 keeps the GET request therein.

On the other hand, to send data to be delivered from the server unit 110 to the client unit 140, the server unit 110 transmits the data to the downlink communication repeater 130 using its own protocol (step S331). In more detail, the data transmission means 213 transmits to the downlink communication repeater 130 data received via the data transmission means 212 from the server AP 111. In this situation, the data to be delivered from the server unit 110 to the client unit 140 includes data which is sent from any other client unit to the server unit 110 and which is addressed to the client unit 140, data to be transmitted to the client unit 140 at update of the server unit 110, and the like.

The downlink communication repeater 130 receives data to be sent to the client unit 140 (step S322) and then retrieves a GET request whose transmission source is the transmission destination client unit 140 from the blocked GET requests (step S323). More specifically, the data reception means 231 issues a query to the transmission destination identifying means 234 to determine whether or not a downlink connection has been established to the client unit 140; in response thereto, the transmission destination identifying means 234 makes a search through the GET requests kept therein; if the GET requests kept therein include the GET request sent from the client unit 140, it is assumed that the downlink connection has been established to the client unit 140.

Next, the downlink communication repeater 130 creates a GET response to the retrieved GET request, stores the data to be transmitted in the HTTP body section of the GET response, and transmits the response (step S324). More specifically, the data reception means 231 passes the data to be sent to the client unit 140 via the transmission destination identifying means 234 to the HTTP GET response creation means 233; the HTTP GET response creation means 233 creates a GET response including the to-be-transmitted data in the HTTP body section and sends the response by use of the HTTP GET response transmission means 235 to the client unit 140.

The client unit 140 receives the GET response (step S312), extracts data from its body section, and passes it to the client AP 141 (step S313). More concretely, the HTTP GET response reception means 245 receives the GET response, and the HTTP GET response analysis means 247 attains data from the HTTP body section of the GET response to pass it via the data reception means 250 to the client AP 141.

Finally, to receive next downlink data, the client unit 140 again sends an HTTP GET request to the downlink communication repeater 130 (step S311).

FIGS. 5 to 8 are data examples in which a text is exchanged between chat APs existing as server APs on client units A and B via a chat server AP existing as a server AP on the server unit 110.

Data used when a text is sent from the client unit A to the client unit B is shown in FIG. 5. To transmit the data to the server unit 110, the data is converted into an HTTP POST request shown in FIG. 6.

The server unit having received the HTTP POST request extracts the data shown in FIG. 5 from the HTTP POST request shown in FIG. 6 and transfers the data to the downlink communication repeater 130.

The downlink communication repeater 130 recognizes that the destination is the client unit B from the data shown in FIG. 5.

On the other hand, to receive data from the chat server AP, the client units A and B beforehand send an HTTP GET request to the downlink communication repeater 130; the GET request in this case is shown in FIG. 7. The downlink communication repeater 130 transmits data as a GET response to the HTTP GET request from the client unit B as the destination; the GET response in this situation is shown in FIG. 8.

### Advantage of First Exemplary Embodiment

In accordance with the first exemplary embodiment, there can be obtained an advantage in which even if the number of connections which can be simultaneously established in the server unit 110 is limited, it is possible to simultaneously conduct two-way communication with many client units. The reason therefor resides in that when data is sent from the client units 140 and 150 to the server unit 110, the data is transmitted via an uplink connection established between the client units 140 and 150 and the server unit 110; when data is sent from the server unit 110 to the client units 140 and 150, the server unit 110 transmits to the downlink communication repeater 130 data to be sent to the client units 140 and 150, and the downlink communication repeater 130 sends the data to the client units 140 and 150 via a downlink connection established between itself and the client units 140 and 150. That is, in the server unit 110, only the uplink connection of the uplink and down link connections which are essential to conduct two-way communication with the client units 140 and 150 is required to be established; therefore, when compared with the conventional techniques in which both of the uplink and down link connections are required to be established, the number of client units which can simultaneously conduct two-way communication is doubled.

### Second Exemplary Embodiment

Next, description will be given in detail of a second exemplary embodiment of the two-way communication system in accordance with the present invention. This exemplary embodiment is characterized in that a plurality of server units shares one downlink communication repeater.

Referring to FIG. 9, the exemplary embodiment includes two server units 810 and 820, a downlink communication repeater 830, and four client units 840, 850, 860, and 870. Although the diagram shows only two server units 810 and 820, no problem occurs even if three or more server units are employed in the configuration. Furthermore, although only four client units 840 to 870 are shown, it is also possible five or more client units are disposed within the range of the restriction for the number of connections which can be simultaneously established.

The server units 810 and 820 include server APs 811 and 821 as well as communication modules 812 and 822 for communication with the downlink communication repeater 830 and the client units 840 to 870. The downlink communication repeater 830 includes a communication module 832 for communication with the server units 810 and 820 and the client units 840 to 870. The client units 840 to 870 include client APs 841, 851, 861, and 871 and communication modules 842, 852, 862, and 872 for communication with the server units 810 and 820 and the downlink communication repeater 830. In this regard, the server units 810 and 820 have a configuration similar to that of the server unit 110 shown in FIG. 2, the downlink communication repeater 830 has a configuration similar to that of the downlink communication repeater 130 shown in FIG. 2, and the client units 840 to 870 have a configuration similar to that of the client unit 140 shown in FIG. 2. Moreover, the server units, the client units, and the downlink communication repeater can be implemented by a computer as in the first exemplary embodiment.

In this case, the server AP 811 included in the server unit 810 and the server AP 821 included in the server unit 820 are same application programs requiring two-way communication with a client AP or application programs which are different from each other as server APs, but are server APs capable of conducting two-way communication with one and the same client AP (more specifically, capable of sharing the downlink connection from the downlink communication repeater 830).

When data is sent from the client AP 841 to the server AP 811, the communication module 842 in the client unit 840 sends an HTTP request (HTTP POST request) according to the HTTP POST method to communication module 812 in the server unit 810. In the diagram, the flow of uplink data from the client AP to the server AP is indicated by a solid-line arrow.

Conversely, When data is sent from the server AP 811 to the client AP 841, the communication module 812 in the server unit 810 first transmits data to the communication module 832 in the downlink communication repeater 830. Then, data is sent as an HTTP response to an HTTP request (HTTP GET request) according to the HTTP GET method beforehand transmitted from the communication module 842 in the client unit 840 to the communication module 832 in the downlink communication repeater 830. In FIG. 9, the flow of downlink data from the server AP to the client AP is indicated by a broken-line arrow.

Now, description will be given of a case in which the exemplary embodiment is applied to a chat system.

Assume, for example, that the client units 840 and 850 are having a chat using the server unit 810 and the client units 860 and 870 are having a chat using the server unit 820. A text sent from the client unit 840 reaches the client unit 850 via the server unit 810 and the downlink communication repeater 830. Similarly, a text sent from the client unit 860 reaches the client unit 870 via the server unit 820 and the downlink communication repeater 830. In this manner, the client units 840 and 850 and the client units 860 and 870 construct independent groups for the chat.

Assume here that it is desired to transmit a message to make also the client unit 860 additionally participate in the chat being conducted between the client units 840 and 850. In a situation wherein two or more sets of the server units and the client units are prepared, the respective sets are independent of each other; and hence the message transmission as above is not possible. On the other hand, according to the exemplary embodiment, even in such case, an invitation message sent from, for example, the client unit 840 reaches the client unit 860 via the server 810 and the downlink communication repeater 830. This is because even data pieces from a plurality of server units can be treated as data pieces from a single server unit by passing the data pieces through the downlink communication repeater 830.

### Advantage of Second Exemplary Embodiment

In accordance with the second exemplary embodiment, in addition to the advantage obtained by the first exemplary embodiment, there can be attained an advantage in which when two-way communication is conducted with a plurality of server units, the load on the client units 840 to 870 can be reduced. The reason therefor is as follows. In the first exemplary embodiment, one downlink communication repeater 130 is prepared for one server unit 110. Hence, for a client unit to carry out two-way communication with a plurality (j units) of server units, a downlink connection is required to be established to the j downlink communication repeaters prepared for each server unit; for this purpose, it is required to transmit an HTTP GET request to each of the j downlink communication repeaters. In contrast thereto, according to the exemplary embodiment, since the plural server units 810 and 820 share one downlink communication repeater 830, it is only necessary for the client units 840 to 870 to transmit an HTTP GET request to one downlink communication repeater 830, and the load is reduced.

As above, a first two-way communication system to which the present invention is applied is characterized in that the system includes a plurality of client units, a server unit, and a repeater; each of the plural client units includes a client-side communication module to transmit data to the server unit via an uplink connection established between itself and the server unit; the server unit includes a server-side communication module to send data to be sent to the client unit via a junction line to the repeater; and the repeater includes a repeater-side communication module to transmit the data sent from the server unit to the plural client units via downlink connections established between itself and the plural client units.

Moreover, a second two-way communication system to which the present invention is applied is characterized in that the system includes a plurality of client units, a plurality of server units, and a repeater; each of the plural client units includes a client-side communication module to transmit data to the plural server units via uplink connections established between itself and the plural server units; each of the plural server units includes a server-side communication module to send data to be sent to the client unit via a junction line to the repeater; and the repeater includes a repeater-side communication module to transmit the data sent from the plural server units to the plural client units via downlink connections established between itself and the plural client units.

Also, in the above two-way communication system, it is characterized that the server-side communication module transmits data pieces which are sent from the plural client units and which are addressed to other client units, via the junction line to the repeater.

In addition, the two-way communication system described above is characterized in that the uplink connection employs an HTTP POST request and the downlink connection uses an HTTP GET request.

Furthermore, the above two-way communication system is characterized in that the repeater-side communication module stores the HTTP GET requests sent from the plural client units; and if the stored HTTP GET requests include an HTTP GET request whose request source client unit matches the client unit as the transmission destination of the data sent from the server unit, the communication module returns the data to the client unit as a response to the HTTP GET request.

Additionally, the server unit to which the present invention is applied is a server unit as a constituent component of a two-way communication system including a plurality of client units, a server unit, and a repeater; each of the plural client units includes a client-side communication module to transmit data to the server unit via an uplink connection established between itself and the server unit; and the repeater includes a repeater-side communication module to transmit data sent from the server unit to the plural client units via downlink connections established between itself and the plural client units; the server unit being characterized by including a server-side communication module to send data to be sent to the client units, via a junction line to the repeater.

Also, in the server unit described above, the server-side communication module is characterized by transmitting data pieces which are sent from the plural client units and which are addressed to other client units, via the junction line to the repeater.

Moreover, the repeater to which the present invention is applied is a repeater as a constituent component of a two-way communication system including a plurality of client units, a server unit, and a repeater; each of the plural client units includes a client-side communication module to transmit data to the server unit via an uplink connection established between itself and the server unit; and the server unit includes a server-side communication module to send data to be sent to the client unit, via a junction line to the repeater; and the repeater is characterized by including a repeater-side communication module to transmit the data sent from the server unit to the plural client units via downlink connections established between itself and the plural client units.

Also, in the repeater, it is characterized that the repeater-side communication module stores HTTP GET requests sent from the plural client units; and if the stored HTTP GET requests include an HTTP GET request whose request source client unit matches the client unit as the transmission destination of the data sent from the server unit, the communication module returns the data to the client unit as a response to the HTTP GET request.

Additionally, in the two-way communication method to which the present invention is applied, a plurality of client units transmit data pieces to a server unit via uplink connections established between the client units and the server unit, the server unit sends data pieces to be sent to the client units, via a junction line to a repeater, the repeater transmits the data pieces sent from the server unit to the client units via downlink connections established between the repeater and the plural client units.

Furthermore, a first program to which the present invention is applied is a program to implement, by a computer, a server unit as a constituent component of a two-way communication system including a plurality of client units, a server unit, and a repeater; each of the plural client units includes a client-side communication module to transmit data to the server unit via an uplink connection established between itself and the server unit; and the repeater includes a repeater-side communication module to transmit the data sent from the server unit to the plural client units via downlink connections established between itself and the plural client units, the program being characterized by making the computer function as a server-side communication module to send data to be sent to the client units, via a junction line to the repeater.

In addition, in the program described above, the server-side communication module is characterized by transmitting data pieces which are sent from the plural client units and which are addressed to other client units, via the junction line to the repeater.

Additionally, a second program to which the present invention is applied is a program to implement, by a computer, a repeater as a constituent component of a two-way communication system including a plurality of client units, a server unit, and a repeater; each of the plural client units includes a client-side communication module to transmit data to the server unit via an uplink connection established between itself and the server unit; and the server unit includes a server-side communication module to send data to be sent to the client unit via a junction line to the repeater, the program being characterized by making the computer function as a repeater-side communication module to transmit the data sent from the server unit to the plural client units via downlink connections established between the repeater and the plural client units.

Furthermore, in the above program, the repeater-side communication module is characterized by storing the HTTP GET requests sent from the plural client units; and if the stored HTTP GET requests include an HTTP GET request whose request source client unit matches the client unit as the transmission destination of the data sent from the server unit, the communication module returns the data to the client unit as a response to the HTTP GET request.

As above, in the present invention, when data is sent from a client unit to a server unit, the client unit transmits the data directly to the server unit by using an uplink connection established between the client unit and the server unit. In contrast thereto, when data is sent from a server unit to a client unit, the server unit transmits to a repeater data to be sent to the client unit, and the repeater sends the data sent from the server unit, via a downlink connection established between the repeater and the client unit, to the client unit.

In accordance with the present invention, the invention is applicable to uses as a server program and a client program for intervention of a server unit when a text is communicated between client units. Also, the invention is applicable to uses as a server program and a client program to communicate contents of changes on a WEB page when WEB pages are synchronized between client units. Furthermore, the invention is applicable to uses as a WEB conference unit and a program for sending and receiving video and audio data between client units.

As above, while description has been given of the present invention by referring to exemplary embodiments, but the present invention is not restricted by the above exemplary embodiments. Various changes, which can be understood by those of ordinary skill in the art, can be conducted for the configurations and details of the present invention within the scope of the present invention.

This application is based upon and claims the benefit of priority from Japanese patent application No. 2006-291203, filed on Oct. 26, 2006, the disclosure of which is incorporated herein in its entirety by reference.

### BRIEF DESCRIPTION OF DRAWINGS

FIG. 1 is a block diagram to explain a two-way communication system of a related art;

FIG. 2 is a block diagram showing a configuration example of a first exemplary embodiment of the two-way communication system in accordance with the present invention;

FIG. 3 is a block diagram showing a configuration example of a server unit 110, a downlink communication repeater 130, and a client unit 140;

FIG. 4 is a flowchart showing a processing example when data is transmitted from the server unit 110 to the client unit 140;

FIG. 5 is a diagram showing an example of data which a client unit A transmits to a client unit B;

FIG. 6 is a diagram showing an example of an HTTP POST request;

FIG. 7 is a diagram showing an example of an HTTP GET request;

FIG. 8 is a diagram showing an example of an HTTP GET response; and

FIG. 9 is a block diagram showing a configuration example of a second exemplary embodiment of the two-way communication system in accordance with the present invention.

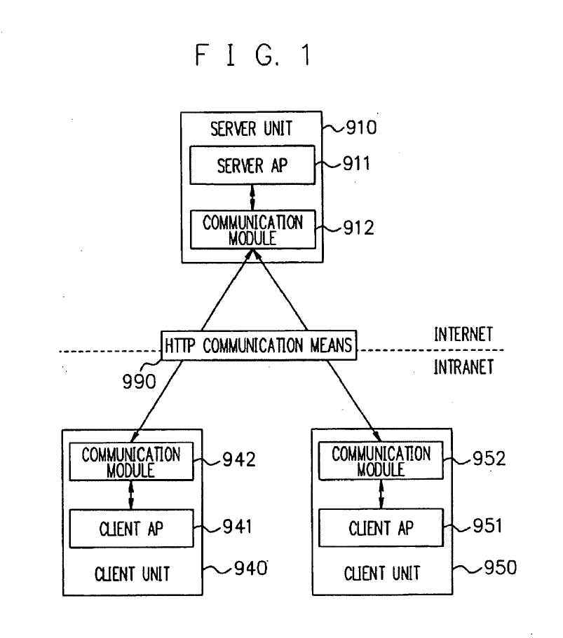

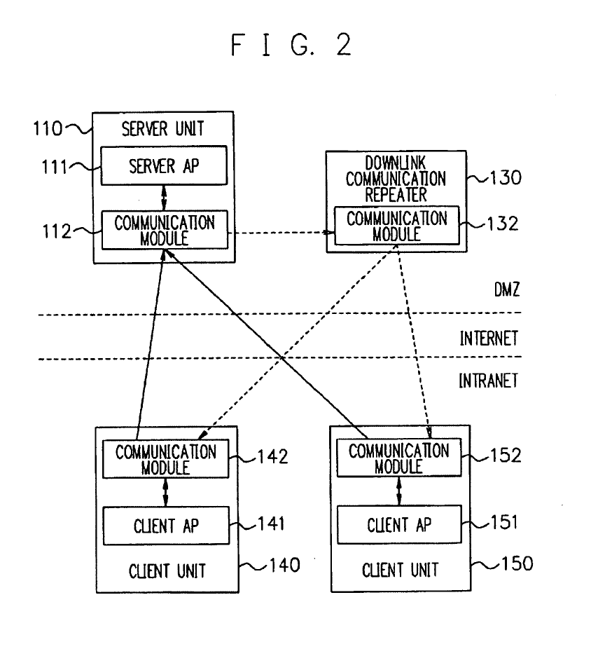

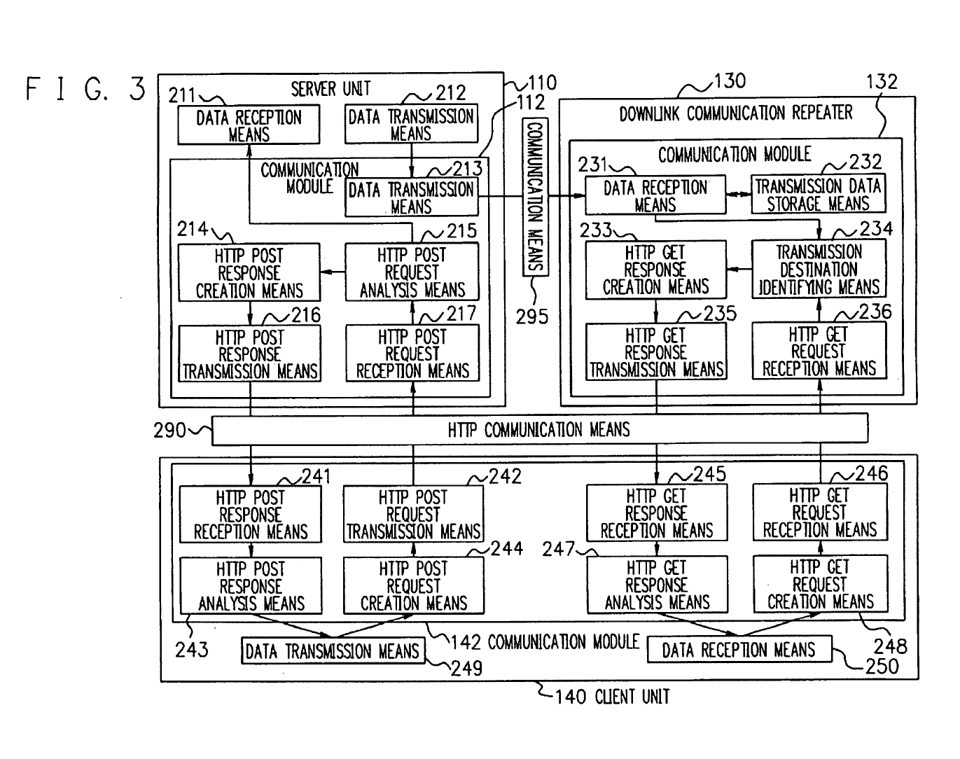

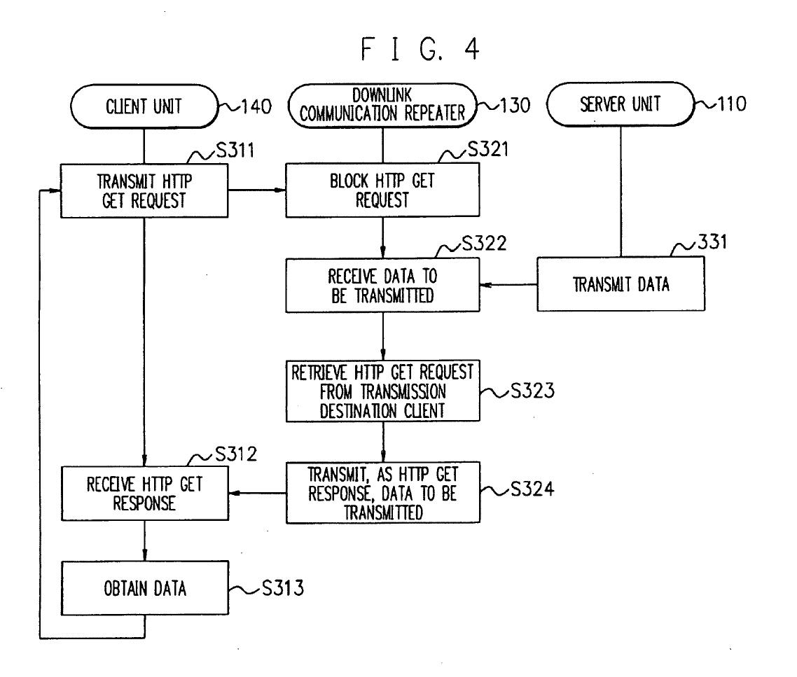

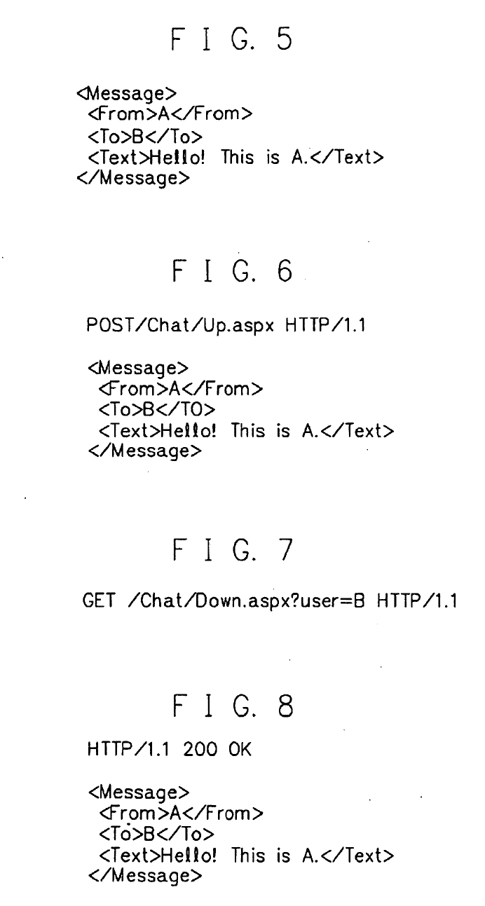

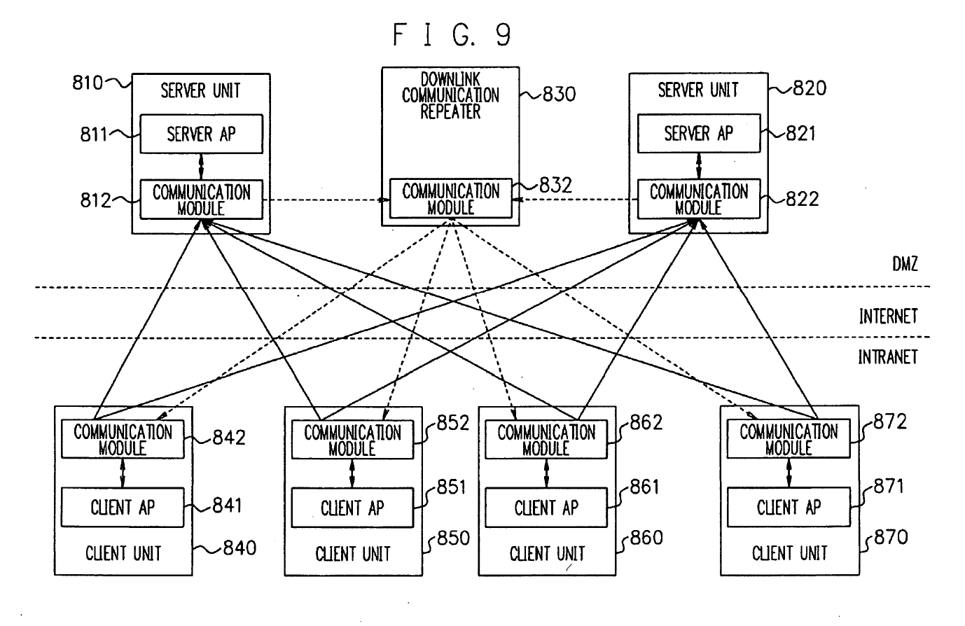

### DESCRIPTION OF REFERENCE NUMERALS

110, 810, 820 Server unit
111, 811, 821 Server AP
112, 812, 822 Communication module
212 Data reception means
213 Data transmission means
213 Data transmission means
214 HTTP POST response creation means
215 HTTP POST request analysis means
216 HTTP POST response transmission means
217 HTTP POST request reception means
130, 830 Downlink communication repeater
132, 832 Communication module
231 Data reception means
232 Transmission data storage means
233 HTTP GET response creation means
234 Transmission destination identifying means
235 HTTP GET response transmission means
236 HTTP GET request reception means
140, 150, 840, 850, 860, 870 Client unit
141, 151, 841, 851, 861, 871 Client AP
142, 152, 842, 852, 862, 872 Communication module
241 HTTP POST response reception means
242 HTTP POST request transmission means
243 HTTP POST response analysis means
244 HTTP POST request creation means
245 HTTP GET response reception means
246 HTTP GET request transmission means
247 HTTP GET response analysis means
248 HTTP GET request creation means
249 Data transmission means
250 Data reception means

1. A two-way communication system comprising:
a plurality of client units;
a server unit; and
a repeater, wherein
each of the plural client units comprises a client-side communication module to transmit data to the server unit via an uplink connection established between itself and the server unit;
the server unit comprises a server-side communication module to send data to be sent to the client unit, via a junction line to the repeater; and
the repeater comprises a repeater-side communication module to transmit the data sent from the server unit to the plural client units via downlink connections established between itself and the plural client units.

2. A two-way communication system comprising:
a plurality of client units;
a plurality of server units; and
a repeater, wherein
each of the plural client units comprises a client-side communication module to transmit data to the plural server units via uplink connections established between itself and the plural server units;
each of the plural server units comprises a server-side communication module to send data to be sent to the client unit, via a junction line to the repeater; and
the repeater comprises a repeater-side communication module to transmit the data sent from the plural server units to the plural client units via downlink connections established between itself and the plural client units.

3. The two-way communication system in accordance with claim 1, wherein the server-side communication module transmits data pieces which are sent from the plural client units and which are addressed to other client units, via the junction line to the repeater.

4. The two-way communication system in accordance with claim 3, wherein
the uplink connection employs an HTTP POST request; and
the downlink connection uses an HTTP GET request.

5. The two-way communication system in accordance with claim 4, wherein the repeater-side communication module stores the HTTP GET requests sent from the plural client units, and if the stored HTTP GET requests include an HTTP GET request whose request source client unit matches the client unit as the transmission destination of the data sent from the server unit, the communication module returns the data to the client unit as a response to the HTTP GET request.

6. A server unit as a constituent component of a two-way communication system comprising a plurality of client units, a server unit, and a repeater, wherein each of the plural client units comprises a client-side communication module to transmit data to the server unit via an uplink connection established between itself and the server unit and the repeater comprises a repeater-side communication module to transmit data sent from the server unit to the plural client units via downlink connections established between itself and the plural client units,
the server unit being characterized by comprising a server-side communication module to send data to be sent to the client units, via a junction line to the repeater.

7. The server unit in accordance with claim 6, wherein the server-side communication module transmits data pieces which are sent from the plural client units and which are addressed to other client units, via the junction line to the repeater.

8. A repeater as a constituent component of a two-way communication system comprising a plurality of client units, a server unit, and a repeater, wherein each of the plural client units comprises a client-side communication module to transmit data to the server unit via an uplink connection established between itself and the server unit, and the server unit comprises a server-side communication module to send data to be sent to the client unit, via a junction line to the repeater,
the repeater being characterized by comprising a repeater-side communication module to transmit the data sent from the server unit to the plural client units via downlink connections established between itself and the plural client units.

9. The repeater in accordance with claim 8, wherein the repeater-side communication module stores HTTP GET requests sent from the plural client units; and if the stored HTTP GET requests include an HTTP GET request whose request source client unit matches the client unit as the transmission destination of the data sent from the server unit, the communication module returns the data to the client unit as a response to the HTTP GET request.

10. A two-way communication method, wherein:
a plurality of client units transmits data pieces to a server unit via an uplink connections established between the client units and the server unit;
the server unit sends data pieces to be sent to the client units, via a junction line to a repeater;
the repeater transmits the data pieces sent from the server unit to the client units via downlink connections established between the repeater and the plural client units.

11. A storage medium for storing a program to implement, by a computer, a server unit as a constituent component of a two-way communication system comprising a plurality of client units, a server unit, and a repeater, wherein each of the plural client units comprises a client-side communication module to transmit data to the server unit via an uplink connection established between itself and the server unit, and the repeater comprises a repeater-side communication module to transmit the data sent from the server unit to the plural client units via downlink connections established between itself and the plural client units,
the program making the computer function as a server-side communication module to send data to be sent to the client units, via a junction line to the repeater.

12. The storage medium for storing the program in accordance with claim 11, wherein the server-side communication module transmits data pieces which are sent from the plural client units and which are addressed to other client units, via the junction line to the repeater.

13. A storage medium for storing a program to implement, by a computer, a repeater as a constituent component of a two-way communication system comprising a plurality of client units, a server unit, and a repeater wherein each of the plural client units comprises a client-side communication module to transmit data to the server unit via an uplink connection established between itself and the server unit, and the server unit comprises a server-side communication module to send data to be sent to the client unit via a junction line to the repeater,
the program making the computer function as a repeater-side communication module to transmit the data sent from the server unit to the plural client units via downlink connections established between the repeater and the plural client units.

14. The storage medium for storing the program in accordance with claim 13, wherein the repeater-side communication module stores the HTTP GET requests sent from the plural client units; and if the stored HTTP GET requests include an HTTP GET request whose request source client unit matches the client unit as the transmission destination of the data sent from the server unit, the communication module returns the data to the client unit as a response to the HTTP GET request.

15. The two-way communication system in accordance with claim 2, wherein the server-side communication modules transmit data pieces which are sent from the plural client units and which are addressed to other client units, via the junction lines to the repeater.

16. The two-way communication system in accordance with claim 15, wherein
the uplink connection employs an HTTP POST request; and
the downlink connection uses an HTTP GET request.

17. The two-way communication system in accordance with claim 16, wherein the repeater-side communication module stores the HTTP GET requests sent from the plural client units, and if the stored HTTP GET requests include an HTTP GET request whose request source client unit matches the client unit as the transmission destination of the data sent from the server unit, the communication module returns the data to the client unit as a response to the HTTP GET request.
